(19) United States
(12) Patent Application Publication
(10) Pub. No.: US 2025/0074060 A1
(43) Pub. Date: Mar. 6, 2025

(54) PRINTING DEVICE, CONTROL METHOD OF PRINTING DEVICE, AND NON-TRANSITORY COMPUTER READABLE STORAGE MEDIUM

(71) Applicant: BROTHER KOGYO KABUSHIKI KAISHA, Nagoya (JP)

(72) Inventors: Kosuke TAKATA, Nagoya (JP); Akihito KOBAYASHI, Konan (JP)

(21) Appl. No.: 18/810,943

(22) Filed: Aug. 21, 2024

(30) Foreign Application Priority Data
Aug. 31, 2023 (JP) 2023-140977

(51) Int. Cl. B41J 2/165; B41J 2/17

(52) U.S. Cl. CPC B41J 2/16505; B41J 2/1721; B41J 2002/16594

(57) ABSTRACT

A printing device includes an inkjet head including a nozzle surface on which a nozzle configured to eject ink is opened, a cap, a cleaning liquid tank configured to be connected to the cap through a cleaning liquid flow path, the cleaning liquid tank being configured to store a cleaning liquid, a waste liquid tank configured to be connected to the cap through a waste liquid flow path, the waste liquid tank being configured to store a waste liquid including at least one of the ink or the cleaning liquid supplied to the cap, and a controller. The controller is configured to selectively perform first maintenance processing of the nozzle using the cleaning liquid, and second maintenance processing of the nozzle using the cleaning liquid, the second maintenance processing having a smaller amount of the waste liquid than the first maintenance processing.

### REFERENCE TO RELATED APPLICATIONS

This application claims priority from Japanese Patent Application No. 2023-140977 filed on Aug. 31, 2023. The entire content of the priority application is incorporated herein by reference.

### BACKGROUND ART

As a related-art printing device, for example, a liquid ejection device is known. The liquid ejection device includes a head provided with a nozzle surface on which nozzles are opened, a suction cap covering the nozzle surface, a liquid discharge path connected to the suction cap, and a suction pump provided in the liquid discharge path. In a maintenance and recovery operation of the head, when the suction pump is driven in a state where the liquid discharge path is closed and the nozzle surface is covered by the suction cap, the inside of the suction cap becomes negative pressure, and the ink is suctioned from the nozzles into the suction cap. Then, when the inside of the suction cap reaches an operation pressure of a check valve of the suction pump, the check valve opens, a cleaning liquid is supplied into the suction cap, and the suction cap and the nozzle surface are cleaned.

In the liquid ejection device of the related art, the suction of the ink from the nozzles by a suction operation performed by the suction pump and the cleaning of the nozzle surface by the cleaning liquid are performed, thereby suppressing non-ejection of the head. However, there is a problem that waste liquid containing at least one of the ink and the cleaning liquid is generated.

An object of the present disclosure is to provide a printing device, a control method of the printing device, and a non-transitory computer readable storage medium storing a computer program capable of reducing an amount of waste liquid while suppressing non-ejection of a head.

### SUMMARY

A printing device including: a inkjet head including a nozzle surface on which a nozzle configured to eject ink is opened; a cap configured to be in contact with the nozzle surface; a cleaning liquid tank configured to be connected to the cap through a cleaning liquid flow path, the cleaning liquid tank being configured to store a cleaning liquid; a waste liquid tank configured to be connected to the cap through a waste liquid flow path, the waste liquid tank being configured to store a waste liquid including at least one of the ink or the cleaning liquid supplied to the cap; and a controller, in which the controller is configured to selectively perform: first maintenance processing of the nozzle using the cleaning liquid; and second maintenance processing of the nozzle using the cleaning liquid, the second maintenance processing having a smaller amount of the waste liquid than the first maintenance processing.

A control method of a printing device, the printing device including: an inkjet head including a nozzle surface on which a nozzle configured to eject ink is opened; a cap configured to be in contact with the nozzle surface; a cleaning liquid tank configured to be connected to the cap through a cleaning liquid flow path, the cleaning liquid tank being configured to store a cleaning liquid; and a waste liquid tank configured to be connected to the cap through a waste liquid flow path, the waste liquid tank being configured to store a waste liquid including at least one of the ink or the cleaning liquid supplied to the cap, the control method including: selectively performing: first maintenance processing of the nozzle using the cleaning liquid; and second maintenance processing of the nozzle using the cleaning liquid, the second maintenance processing having a smaller amount of the waste liquid than the first maintenance processing.

A non-transitory computer readable storage medium storing a computer program executed by a printing device, the printing device includes: an inkjet head including a nozzle surface on which a nozzle configured to eject ink is opened; a cap configured to be in contact with the nozzle surface; a cleaning liquid tank configured to be connected to the cap through a cleaning liquid flow path, the cleaning liquid tank being configured to store a cleaning liquid; and a waste liquid tank configured to be connected to the cap through a waste liquid flow path, the waste liquid tank being configured to store a waste liquid including at least one of the ink or the cleaning liquid supplied to the cap, the computer program comprising an instruction that causes the printing device to selectively perform: first maintenance processing of the nozzle using the cleaning liquid; and second maintenance processing of the nozzle using the cleaning liquid, the second maintenance processing having a smaller amount of the waste liquid than the first maintenance processing.

### BRIEF DESCRIPTION OF DRAWINGS

FIG. 1 is a perspective view of a printing device.

FIG. 2 is a functional block diagram illustrating a configuration of the printing device.

FIG. 3 is a diagram schematically illustrating a head and a maintenance device.

FIG. 4A is a flowchart illustrating an example of first maintenance processing.

FIG. 4B is a flowchart illustrating an example of second maintenance processing.

FIG. 5 is a diagram for illustrating an ink suction operation.

FIG. 6 is a diagram for illustrating a first waste liquid suction operation.

FIG. 7 is a diagram for illustrating a first cleaning liquid introduction operation.

FIG. 8A is a diagram illustrating a driving period of a pump in the first cleaning liquid introduction operation of the first maintenance processing.

FIG. 8B is a diagram illustrating a driving period of the pump in a second cleaning liquid introduction operation of the second maintenance processing.

FIG. 9 is a diagram for illustrating a second waste liquid suction operation.

FIG. 10 is a diagram for illustrating a third waste liquid suction operation.

FIG. 11 is a diagram for illustrating a wiping operation.

FIG. 12 is a diagram for illustrating the second cleaning liquid introduction operation.

FIG. 13A is a top view of a cap into which cleaning liquid is introduced in the first cleaning liquid introduction operation.

FIG. 13B is a top view of the cap into which the cleaning liquid is introduced in the second cleaning liquid introduction operation.

FIG. 13C is a top view of the cap in which the cleaning liquid moves in the second waste liquid suction operation.

FIG. 14 is a flowchart illustrating an example of maintenance of the printing device.

### DESCRIPTION

Hereinafter, embodiments of the present disclosure will be specifically described with reference to the drawings. In the following description, the same or corresponding elements in all the drawings are denoted by the same reference numerals, and redundant description thereof is omitted.

### Printing Device

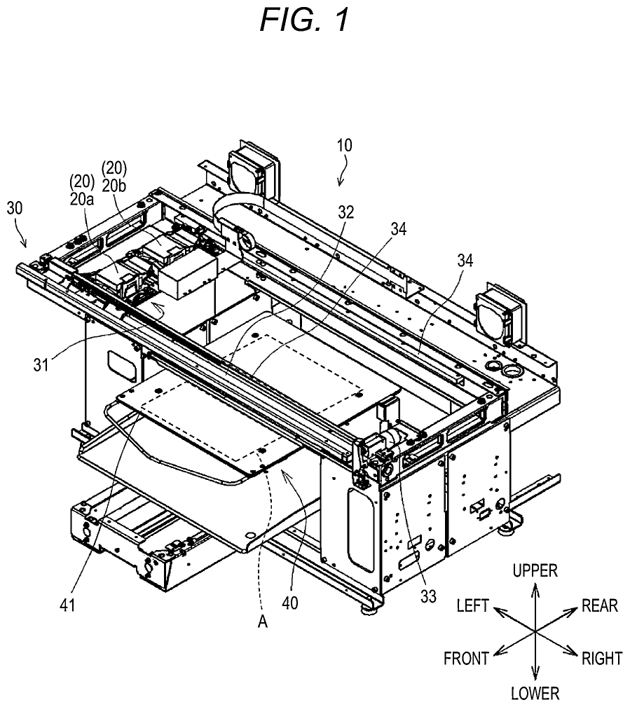

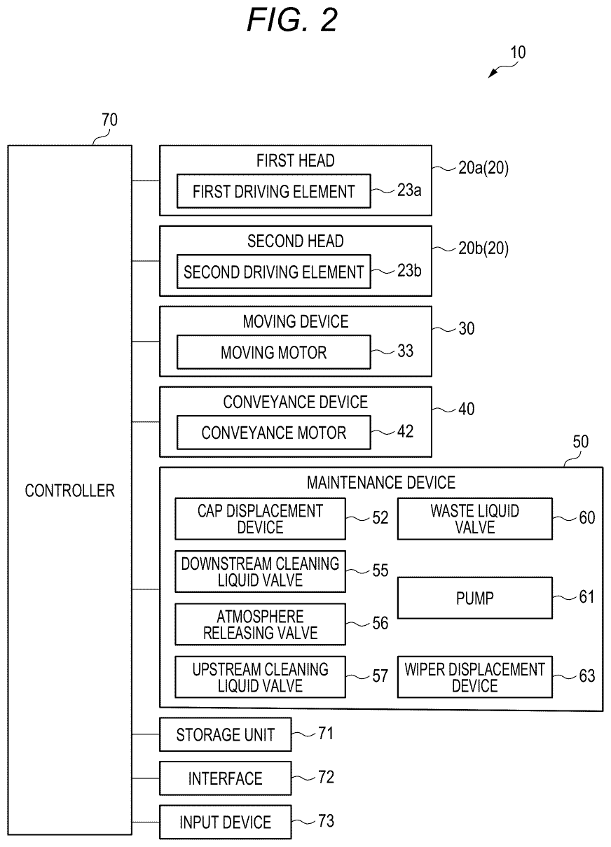

As illustrated in FIGS. 1 and 2, a printing device 10 according to an embodiment of the present disclosure is an inkjet printer configured to eject ink onto a printed medium A and configured to print an image on the printed medium A. For example, in a case where fabric is used as the printed medium A, the printing device 10 is a garment printer.

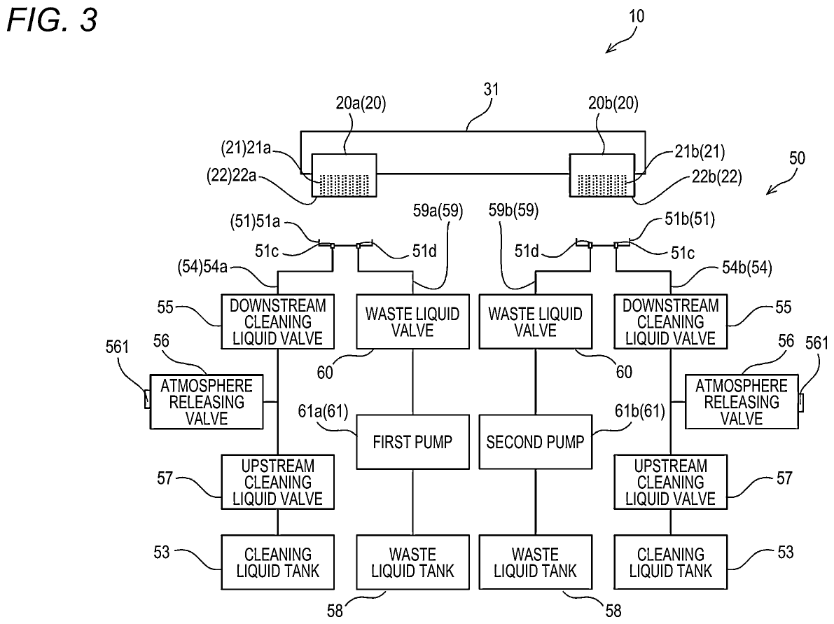

The printing device 10 includes an inkjet head (hereinafter, referred to as a head) 20. The head 20 includes a first head 20a and a second head 20b. As illustrated in FIG. 3, the first head 20a includes a plurality of first nozzles 21a and a first nozzle surface 22a that is a lower surface on which the first nozzles 21a are opened. Further, as illustrated in FIG. 2, the first head 20a includes first driving elements 23a. The first driving element 23a is, for example, a piezoelectric element. The first driving element 23a is provided for each first nozzle 21a. The first driving element 23a is configured to apply, to the first ink of the first head 20a, a pressure for ejecting first ink from the first nozzle 21a. The first nozzle 21a is configured to eject the first ink onto the printed medium A using driving of the first driving element 23a. The first ink is color ink such as cyan ink, magenta ink, yellow ink, and black ink.

As illustrated in FIG. 3, the second head 20b includes a plurality of second nozzles 21b and a second nozzle surface 22b that is a lower surface on which the second nozzles 21b are opened. Further, as illustrated in FIG. 2, the second head 20b includes second driving elements 23b. The second driving element 23b is, for example, a piezoelectric element. The second driving element 23b is provided for each second nozzle 21b. The second driving element 23b is configured to apply, to the second ink of the second head 20b, a pressure for ejecting second ink from the second nozzle 21b.

The second nozzle 21b is configured to eject the second ink onto the printed medium A using driving of the second driving element 23b. The second ink is different from the first ink. The second ink is more easily dried than the first ink. The second ink is, for example, white ink. The white ink contains a pigment such as titanium oxide. The white ink is more easily dried than the color ink. Hereinafter, each of the first nozzles 21a and the second nozzles 21b may be referred to as a nozzle 21, and each of the first nozzle surface 22a and the second nozzle surface 22b may each be referred to as a nozzle surface 22.

As illustrated in FIGS. 1 and 2, the printing device 10 further includes a moving device 30 configured to move the first head 20a and the second head 20b. The moving device 30 includes a carriage 31, an endless belt 32, a moving motor 33, and a pair of rails 34. The carriage 31 is configured to mount the first head 20a and the second head 20b. The carriage 31 is supported by the pair of rails 34. The carriage 31 is connected to the endless belt 32. The pair of rails 34 extend in a left-right direction while being spaced apart from each other in a front-rear direction. The endless belt 32 extends in the left-right direction and is connected to the moving motor 33 via a pulley. In a case where the moving motor 33 is driven, the endless belt 32 travels to move the carriage 31, the first head 20a, and the second head 20b in the left-right direction along the rails 34.

The printing device 10 further includes a conveyance device 40 configured to convey the printed medium A. The conveyance device 40 includes a platen 41, a linear-motion actuator, and a conveyance motor 42. The platen 41 has a flat plate shape. The printed medium A is placed on an upper surface of the platen 41. The linear-motion actuator has, for example, a ball screw and a nut combined with the ball screw. The nut is connected to the platen 41. The ball screw is connected to the conveyance motor 42. In a case where the conveyance motor 42 is driven, the nut moves in the front-rear direction with respect to the ball screw, and the platen 41 and the printed medium A move in the front-rear direction in accordance with this.

As illustrated in FIGS. 2 and 3, the printing device 10 further includes a maintenance device 50 for the head 20. The maintenance device 50 includes a cap 51 and a cap displacement device 52. The cap 51 is made of an elastic member such as rubber. The cap 51 has, for example, a rectangular parallelepiped shape. The cap 51 has an internal space and an opening of the internal space provided at an upper portion of the internal space. The caps 51 include a first cap 51a and a second cap 51b. The first cap 51a is disposed below the first nozzle surface 22a of the first head 20a. The second cap 51b is disposed below the second nozzle surface 22b of the second head 20b.

The cap displacement device 52 is provided in the first head 20a and the second head 20b. The cap displacement device 52 of the first head 20a is configured to displace (for example, moves up and down) the first cap 51a between a contact position where the first cap 51a is in contact with the first nozzle surface 22a, and a separation position where the first cap 51a is separated from the first nozzle surface 22a. The cap displacement device 52 of the second head 20b is configured to displace (for example, move up and down) the second cap 51b between a contact position where the second cap 51b is in contact with the second nozzle surface 22b, and a separation position where the second cap 51b is separated from the second nozzle surface 22b.

At this contact position, an upper end of the first cap 51a is in contact with the first nozzle surface 22a, and an upper opening of an internal space of the first cap 51a is covered by the first nozzle surface 22a. Further, an upper end of the second cap 51b is in contact with the second nozzle surface 22b, and an upper opening of an internal space of the second cap 51b is covered by the second nozzle surface 22b. On the other hand, at the separation position, the internal space of the first cap 51a is opened, and the internal space of the second cap 51b is opened.

The maintenance device 50 further includes waste liquid tank 58, waste liquid flow path 59, waste liquid valve 60, and pump 61. Each cap 51 of the first cap 51a and the second cap 51b includes a discharge port 51d. The waste liquid flow path 59 has one end configured to be connected to the discharge port 51d of the cap 51 and the other end configured to be connected to the waste liquid tank 58. The internal space of the cap 51 communicates with the waste liquid tank 58 through the discharge port 51d and the waste liquid flow path 59. The waste liquid tank 58 is configured to store waste liquid containing at least one of the ink and cleaning liquid discharged from the internal space of the cap 51.

The waste liquid valve 60 is provided in the waste liquid flow path 59. The pump 61 is configured to be provided in the waste liquid flow path 59 between the waste liquid valve 60 and the waste liquid tank 58. In a case where the pump 61 is driven in a state where the waste liquid valve 60 is opened and the waste liquid flow path 59 is opened, the internal space of the cap 51 is suctioned through the waste liquid flow path 59. Accordingly, the waste liquid in the internal space of the cap 51 is discharged from the discharge port 51d to the waste liquid tank 58, through the waste liquid flow path 59. A suction force of the pump 61 is variably driven. As the suction force of the pump 61 increases, a pressure in the internal space of the cap 51 decreases. On the other hand, in a case where the waste liquid valve 60 is closed, the waste liquid flow path 59 is closed, and the waste liquid is not discharged to the waste liquid tank 58.

The waste liquid flow path 59 include a first waste liquid flow path 59a connected to the first cap 51a and a second waste liquid flow path 59b connected to the second cap 51b. The waste liquid valve 60 are provided in the first waste liquid flow path 59a and the second waste liquid flow path 59b. The waste liquid tank 58 is configured to be connected to the waste liquid valve 60. In the example of FIG. 3, the first waste liquid flow path 59a and the second waste liquid flow path 59b are connected to different waste liquid tanks 58, but they may be connected to the same waste liquid tank 58. The pump 61 includes a first pump 61a configured to be provided in the first waste liquid flow path 59a and is configured to suction an inside of the first cap 51a, and a second pump 61b configured to be provided in the second waste liquid flow path 59b and is configured to suction an inside of the second cap 51b.

The maintenance device 50 further includes cleaning liquid tank 53, cleaning liquid flow path 54, downstream cleaning liquid valve 55, atmosphere releasing valve 56, and upstream cleaning liquid valve 57. Each cap 51 of the first cap 51a and the second cap 51b has a supply port 51c. One end of the cleaning liquid flow path 54 is configured to be connected to the supply port 51c of the cap 51 and communicates with the internal space of the cap 51, and the other end of the cleaning liquid flow path 54 is configured to be connected to the cleaning liquid tank 53. The cleaning liquid tank 53 is configured to store the cleaning liquid, and supply the cleaning liquid from the supply port 51c to the internal space of the cap 51 through the cleaning liquid flow path 54. The cleaning liquid contains, for example, a component that dissolves the ink

The upstream cleaning liquid valve 57 and the downstream cleaning liquid valve 55 are provided in the cleaning liquid flow path 54. The downstream cleaning liquid valve 55 is disposed downstream of the upstream cleaning liquid valve 57 in a flow of the cleaning liquid in the cleaning liquid flow path 54. In a case where the downstream cleaning liquid valve 55 is closed, the waste liquid containing at least one of the ink and the cleaning liquid in the internal space of the cap 51 is prevented from flowing into the cleaning liquid flow path 54.

In a case where the pump 61 is driven in a state where the downstream cleaning liquid valve 55 and the upstream cleaning liquid valve 57 are opened and the cleaning liquid flow path 54 between the cleaning liquid tank 53 and the supply port 51c of the cap 51 is opened, the cleaning liquid flows from the cleaning liquid tank 53 into the internal space of the cap 51, through the cleaning liquid flow path 54, via the supply port 51c. On the other hand, in a case where at least one of the downstream cleaning liquid valve 55 and the upstream cleaning liquid valve 57 is closed, the cleaning liquid flow path 54 is closed, and the cleaning liquid does not flow into the internal space of the cap 51.

The atmosphere releasing valve 56 is provided in a branch path of the cleaning liquid flow path 54 between the downstream cleaning liquid valve 55 and the upstream cleaning liquid valve 57, and has an atmosphere releasing port 561. In a case where the atmosphere releasing port 561 is opened, the cleaning liquid flow path 54 is opened to the atmosphere. Then, in a case where the downstream cleaning liquid valve 55 and the atmosphere releasing port 561 are opened and the pump 61 is driven, air flows from the atmosphere releasing port 561 into the internal space of the cap 51, through the cleaning liquid flow path 54, via the supply port 51c. On the other hand, in a case where at least one of the downstream cleaning liquid valve 55 and the atmosphere releasing port 561 is closed, air does not flow into the internal space of the cap 51.

The cleaning liquid flow paths 54 include a first cleaning liquid flow path 54a connected to the first cap 51a and a second cleaning liquid flow path 54b connected to the second cap 51b. The downstream cleaning liquid valve 55, the atmosphere releasing valve 56, and the upstream cleaning liquid valve 57 are provided in each of the first cleaning liquid flow path 54a and the second cleaning liquid flow path 54b. Further, the cleaning liquid tank 53 is configured to be connected to the first cleaning liquid flow path 54a and the second cleaning liquid flow path 54b. In the example of FIG. 3, the first cleaning liquid flow path 54a and the second cleaning liquid flow path 54b are connected to different cleaning liquid tanks 53, but they may be connected to the same cleaning liquid tank 53.

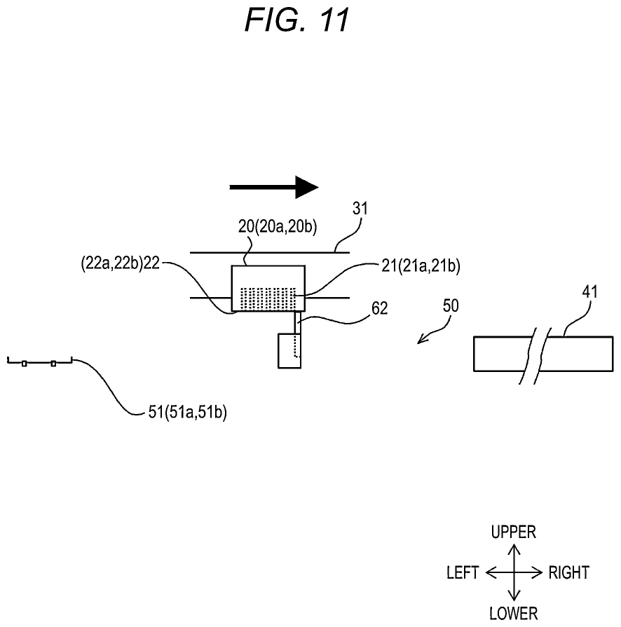

As illustrated in FIGS. 2 and 11, the maintenance device 50 further includes a wiper 62 and a wiper displacement device 63. The wiper 62 is formed of an elastic member such as rubber. The wiper 62 has, for example, a flat plate shape. The wiper 62 is disposed below the nozzle surface 22 of the head 20 in an upper-lower direction, for example, between the platen 41 and the cap 51 in the left-right direction.

The wiper displacement device 63 is configured to displace (for example, moves up and down) the wiper 62 between a contact position where the wiper 62 is in contact with the nozzle surface 22, and a separation position where the wiper 62 is separated from the nozzle surface 22. In a case where the head 20 is moved by the carriage 31 in a state where the nozzle surface 22 is in contact with the wiper 62 disposed at the contact position, the nozzle surface 22 is wiped by the wiper 62, and the ink on the nozzle surface 22 is removed by the wiper 62.

The maintenance device 50 is provided with the wiper 62 for wiping the first nozzle surface 22a and the wiper 62 for wiping the second nozzle surface 22b. The maintenance device 50 includes the wiper displacement device 63 configured to displace the wiper 62 with respect to the first nozzle surface 22a and the wiper displacement device 63 configured to displace the wiper 62 with respect to the second nozzle surface 22b.

As illustrated in FIG. 2, the printing device 10 further includes a controller 70, a storage unit 71 connected to the controller 70, an interface 72, and an input device 73. The interface 72 is connected to other external devices such as a PC and a storage medium, and configured to transmit and receive data between the controller 70 and the external devices. The input device 73 inputs data according to a user operation, such as buttons, keys and a touch pad, to the controller 70.

The storage unit 71 is a memory accessible from the controller 70, and includes a RAM and a ROM. The storage unit 71 is configured to store computer programs for performing various types of data processing such as printing processing and maintenance processing, and data used for the data processing such as printing data. The printing data includes image data (for example, raster data) indicating an image to be printed on the printed medium A. The printing data may be stored in the storage unit 71 or acquired from the external devices via the interface 72. The computer program and the data may be stored in a single storage unit 71 or may be divided and stored in a plurality of storage units 71.

The controller 70 is a computer and includes a processor such as a CPU. The controller 70 is configured to control each unit of the printing device 10 by executing the computer program stored in the storage unit 71, and execute various types of data processing of the printing device 10. The controller 70 may be implemented by a single device configured to perform centralized control, or may be implemented by a plurality of devices that perform distributed control.

### Printing Processing

In the printing device 10, the controller 70 is configured to execute the printing processing based on the printing data. In the printing processing, the controller 70 is configured to alternately repeat a pass for ejecting ink from the nozzles 21 of the head 20 and conveyance for conveying the printed medium A forward or backward while moving the head 20 rightward or leftward. Accordingly, the ink is ejected onto the printed medium A, and an image is printed. Here, a base layer is formed on the printed medium A by the second ink, and an image layer is formed on the base layer by the first ink. The first ink and the second ink may be ejected in the same pass, or a pass in which the first ink is ejected may be performed after a pass in which the second ink is ejected.

### Maintenance Processing

For example, in a case where the ink adhering to the nozzle surface 22 is dried and enters the nozzle 21, non-ejection of the ink from the nozzle 21 may occur. In a case where the ink adhering to the nozzle surface 22 is dried, a wiping performance of the wiper 62 configured to wipe the nozzle surface 22 may be decreased. In a case where the ink adhering to the cap 51 is dried, the waste liquid flow path 59 may be clogged. In order to reduce such a failure, the maintenance processing of the nozzle 21 using the cleaning liquid that dissolves the ink is performed. However, the waste liquid containing at least one of the ink and the cleaning liquid may be generated by the maintenance processing of the nozzle 21. The printing device 10 is configured to selectively execute the first maintenance processing of the nozzle 21 using the cleaning liquid, and the second maintenance processing of the nozzle 21 using the cleaning liquid and having a smaller amount of waste liquid than the first maintenance processing, in order to reduce the amount of the waste liquid while suppressing the non-ejection of the nozzle 21.

### First Maintenance Processing

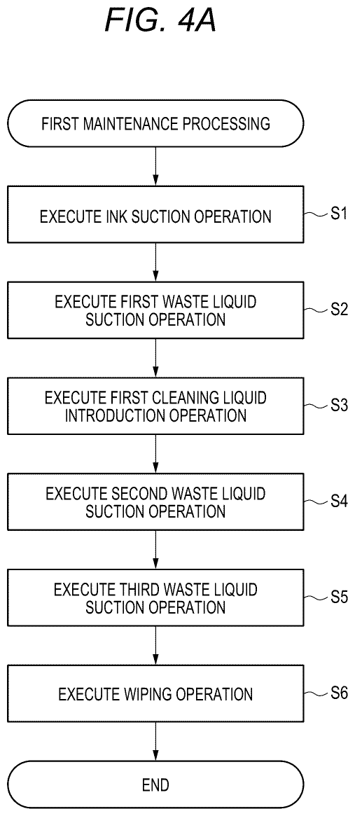

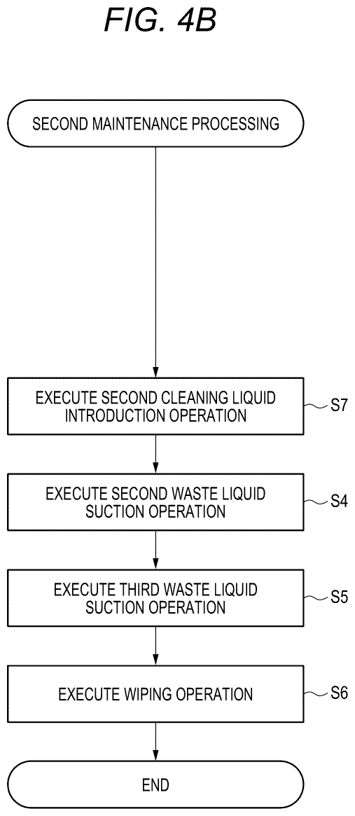

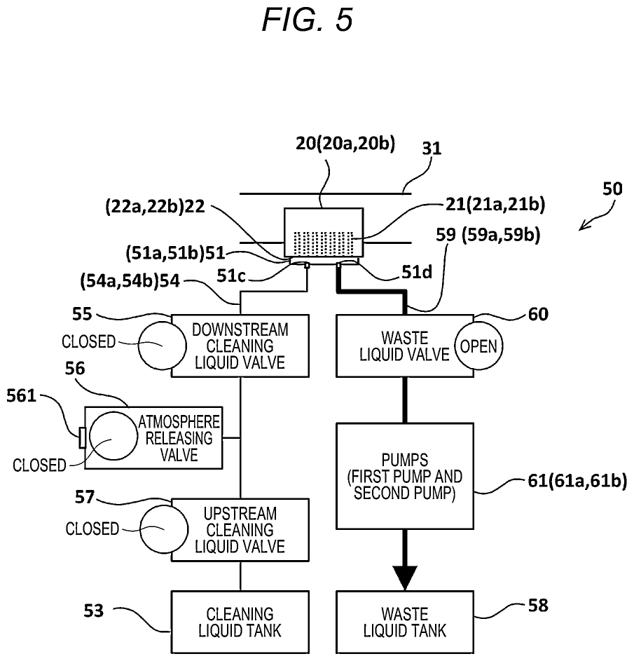

The first maintenance processing is executed by the controller 70 according to a flowchart illustrated in the example of FIG. 4A. In the first maintenance processing, first, the controller 70 executes an ink suction operation (step S1). In the ink suction operation, as illustrated in FIG. 5, the controller 70 disposes the cap 51 at the contact position and causes the cap 51 to come into contact with the nozzle surface 22, thereby covering the internal space of the cap 51 by the nozzle surface 22. In this state, the controller 70 closes the downstream cleaning liquid valve 55, the atmosphere releasing valve 56, and the upstream cleaning liquid valve 57. Accordingly, the cleaning liquid flow path 54 between the supply port 51c of the cap 51 and the cleaning liquid tank 53 and the atmosphere releasing port 561 is closed. The controller 70 may close the cleaning liquid flow path 54 by closing the downstream cleaning liquid valve 55 without closing the atmosphere releasing valve 56 and the upstream cleaning liquid valve 57.

Then, the controller 70 opens the waste liquid valve 60 to open the waste liquid flow path 59. In a case where the controller 70 drives the pump 61, the pump 61 suctions the internal space of the cap 51 through the waste liquid flow path 59. Accordingly, the pressure in the internal space of the cap 51 decreases, and the ink is ejected from the nozzles 21 on the nozzle surface 22 exposed to the internal space. Therefore, even in a case where the nozzle 21 is temporarily in a non-ejection state due to thickened ink by drying, since the thickened ink is discharged from the nozzle 21, the non-ejection of the nozzle 21 can be suppressed. The ink and the thickened ink are discharged as the waste liquid from the nozzles 21 into the cap 51, and discharged from the discharge port 51d of the cap 51 to the waste liquid tank 58 through the waste liquid flow path 59. Accordingly, the controller 70 stops the pump 61.

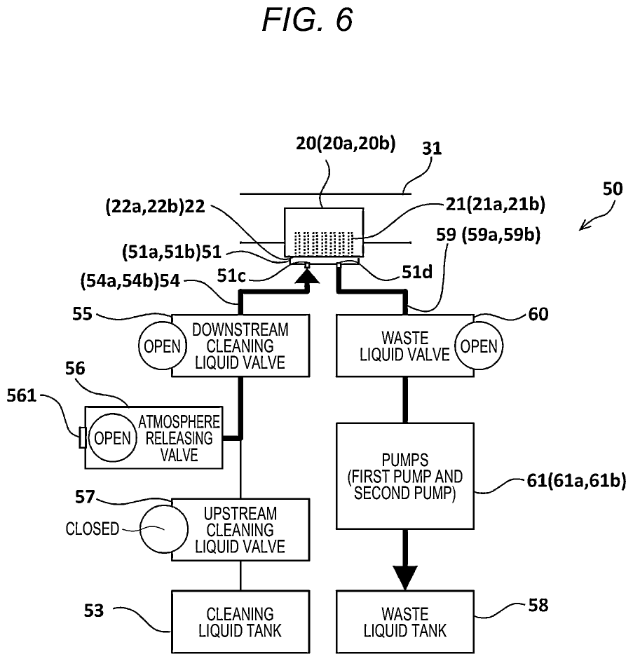

Subsequently, the controller 70 executes a first waste liquid suction operation, as the first maintenance processing, after the ink suction operation (step S2). In the first waste liquid suction operation, as illustrated in FIG. 6, while the cap 51 is in contact with the nozzle surface 22 and the upper opening of the internal space of the cap 51 is covered by the nozzle surface 22, the controller 70 closes the upstream cleaning liquid valve 57 and opens the atmosphere releasing valve 56 and the downstream cleaning liquid valve 55. Accordingly, the cleaning liquid flow path 54 between the supply port 51c of the cap 51 and the cleaning liquid tank 53 is closed, but the cleaning liquid flow path 54 between the supply port 51c of the cap 51 and the atmosphere releasing port 561 is opened. Accordingly, the atmosphere releasing port 561 and the internal space of the cap 51 communicate with each other. Since specific gravity of the air is smaller than specific gravity of the cleaning liquid, the upstream cleaning liquid valve 57 may be opened together with the atmosphere releasing valve 56 and the downstream cleaning liquid valve 55.

In a case where the controller 70 drives the pump 61 in a state where the waste liquid valve 60 is opened and the waste liquid flow path 59 is opened, the internal space of the cap 51 is suctioned through the waste liquid flow path 59. A flow path resistance of air in the cleaning liquid flow path 54 communicating with the internal space of the cap 51 is smaller than a flow path resistance of ink in the nozzles 21 communicating with the internal space of the cap 51. Accordingly, the air flows into the internal space of the cap 51 through the cleaning liquid flow path 54 from the atmosphere releasing port 561 while the ejection of the ink from the nozzles 21 is reduced, the waste liquid in the cap 51 is discharged to the waste liquid tank 58 from the discharge port 51d of the cap 51 through the waste liquid flow path 59.

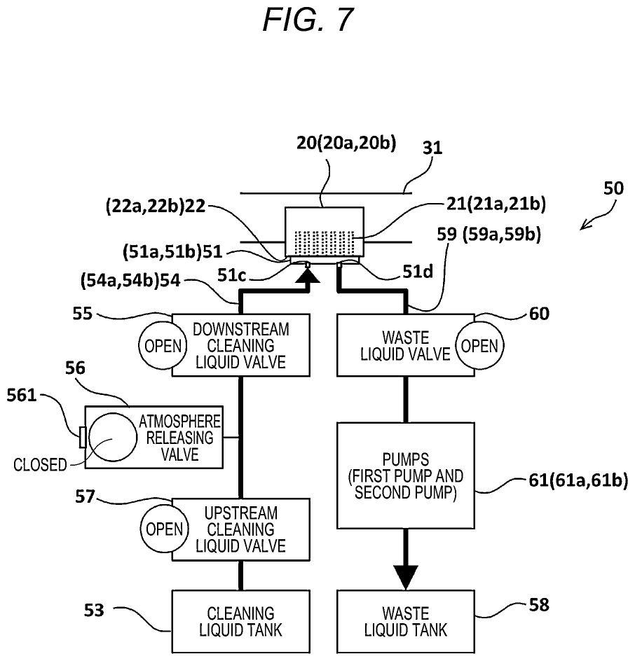

Subsequently, the controller 70 executes a first cleaning liquid introduction operation, as the first maintenance processing, after the first waste liquid suction operation (step S3). In the first cleaning liquid introduction operation, as illustrated in FIG. 7, while the cap 51 is in contact with the nozzle surface 22 and the upper opening of the internal space of the cap 51 is covered by the nozzle surface 22, the controller 70 closes the atmosphere releasing valve 56 and opens the downstream cleaning liquid valve 55 and the upstream cleaning liquid valve 57. Accordingly, the atmosphere releasing port 561 is closed, but the cleaning liquid flow path 54 between the supply port 51c of the cap 51 and the cleaning liquid tank 53 is opened. Accordingly, the cleaning liquid tank 53 and the internal space of the cap 51 communicate with each other.

In a case where the controller 70 drives the pump 61 in a state where the waste liquid valve 60 is opened and the waste liquid flow path 59 is opened, the internal space of the cap 51 is suctioned through the waste liquid flow path 59. Accordingly, the cleaning liquid is introduced into the internal space of the cap 51 from the cleaning liquid tank 53 through the cleaning liquid flow path 54, and an inner surface forming the internal space of the cap 51 and the nozzle surface 22 exposed to the internal space of the cap 51 are cleaned by the cleaning liquid introduced into the internal space.

Accordingly, the dry ink adhering to the inner surface of the cap 51 is removed by the cleaning liquid, and it is possible to suppress a failure such as clogging of the waste liquid flow path 59 which suppresses a failure such as the non-ejection of the ink from the nozzles 21 and the decrease in the wiping performance of the wiper 62 caused by the dry ink. Further, the dry ink adhering to the nozzle surface 22 is removed by the cleaning liquid, and it is possible to suppress a failure such as the non-ejection of the nozzles 21 and the decrease in the wiping performance of the wiper 62 caused by the dry ink. Even in a case where there is a nozzle 21 in which the non-ejection is not resolved even in the ink suction operation among the nozzles 21 opened in the nozzle surface 22, the non-ejection of the nozzle 21 can be suppressed by removing the thickened ink in the nozzle 21 by the cleaning liquid.

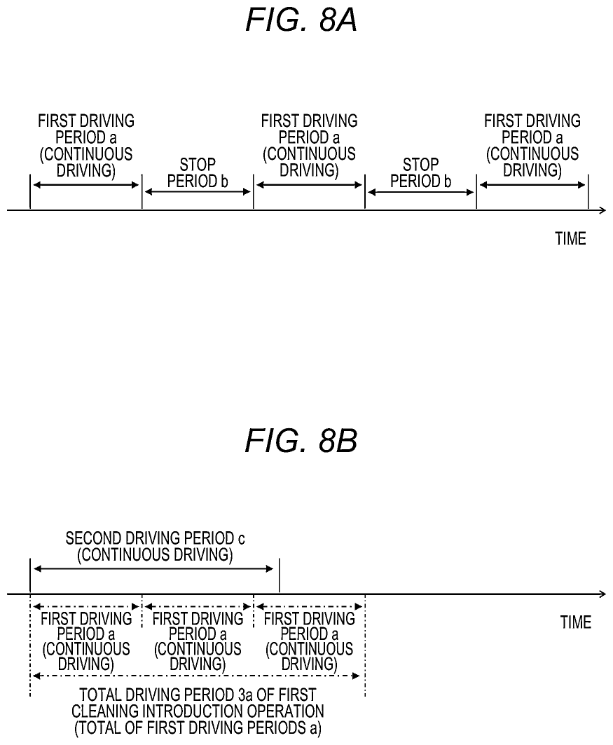

In the first cleaning liquid introduction operation, the controller 70 intermittently drives the pump 61. For example, as illustrated in FIG. 8A, the controller 70 continuously drives the pump 61 during a first driving period a, and then stops the pump 61 during a stop period b. The controller 70 repeats the continuous driving of the pump 61 in the first driving period a predetermined number of times (for example, three times) while stopping the pump 61 between the continuous driving of the pump 61.

During the stop of the pump 61 between the continuous driving of the pump 61, the pressure in the internal space of the cap 51 rises by a small amount of atmosphere entering the cap 51. Accordingly, in the first cleaning liquid introduction operation, the pressure in the internal space of the cap 51 is less likely to be lower than the predetermined pressure that causes meniscus break in the nozzle 21 due to suction by the pump 61 in the case where the stop period b is included and the pump 61 is intermittently driven than in the case where the stop period b is not included and the pump 61 is continuously driven. Therefore, the controller 70 is configured to introduce the cleaning liquid into the internal space of the cap 51 while reducing the occurrence of meniscus break. Thus, in addition to the ink suction operation, ink ejection from the nozzles 21 due to the meniscus break is suppressed in the first cleaning liquid introduction operation. Thus, an increase in the amount of the waste liquid containing the ink can be reduced.

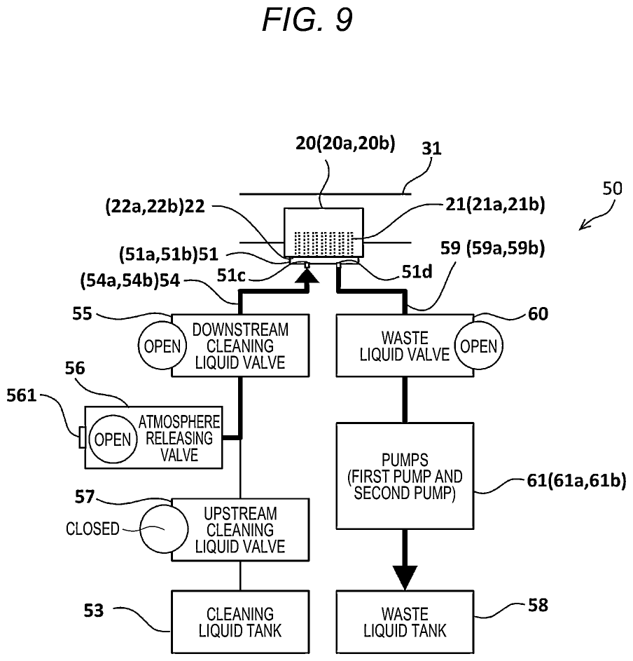

Subsequently, the controller 70 executes a second waste liquid suction operation, as the first maintenance processing, after the first cleaning liquid introduction operation (step S4). In the second waste liquid suction operation, as illustrated in FIG. 9, the controller 70 closes the upstream cleaning liquid valve 57 and opens the atmosphere releasing valve 56 and the downstream cleaning liquid valve 55 while the cap 51 is in contact with the nozzle surface 22 and the upper opening of the internal space of the cap 51 is covered by the nozzle surface 22. Accordingly, the cleaning liquid flow path 54 between the supply port 51c of the cap 51 and the cleaning liquid tank 53 is closed, but the cleaning liquid flow path 54 between the supply port 51c of the cap 51 and the atmosphere releasing port 561 is opened. Accordingly, the atmosphere releasing port 561 and the internal space of the cap 51 communicate with each other.

In a case where the controller 70 drives the pump 61 in a state where the waste liquid valve 60 is opened and the waste liquid flow path 59 is opened, the internal space of the cap 51 is suctioned through the waste liquid flow path 59. Accordingly, since the air flows into the internal space of the cap 51 through the cleaning liquid flow path 54 from the atmosphere releasing port 561, the ink is not suctioned from the nozzles 21, and the cleaning liquid in the cap 51 is discharged as the waste liquid from the discharge port 51d of the cap 51 through the waste liquid flow path 59 to the waste liquid tank 58. Then, the controller 70 stops the pump 61.

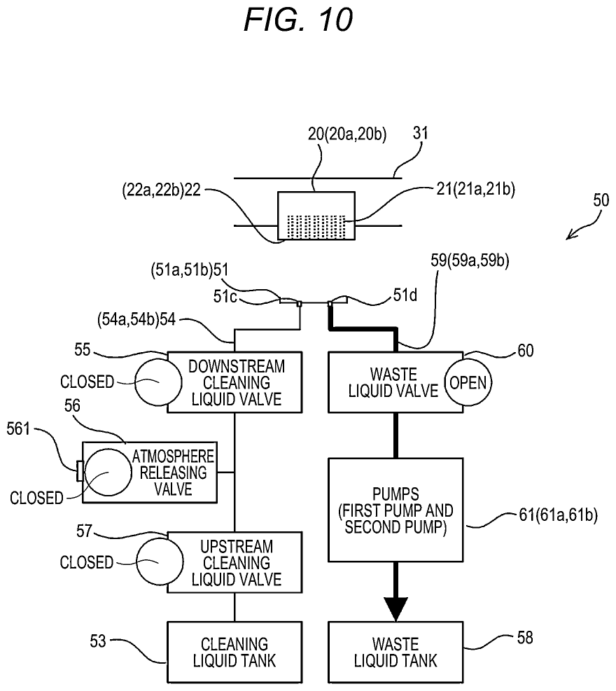

Subsequently, the controller 70 executes a third waste liquid suction operation, as the first maintenance processing, after the second waste liquid suction operation (step S5). In the third waste liquid suction operation, as illustrated in FIG. 10, in a case where the controller 70 disposes the cap 51 at the separation position and separates the cap 51 from the nozzle surface 22, the internal space of the cap 51 is opened to the atmosphere. In this state, the controller 70 closes the downstream cleaning liquid valve 55, the atmosphere releasing valve 56, and the upstream cleaning liquid valve 57 to close the cleaning liquid flow path 54 between the supply port 51c of the cap 51 and the cleaning liquid tank 53 and the atmosphere releasing port 561.

In a case where the controller 70 drives the pump 61 in a state where the waste liquid valve 60 is opened and the waste liquid flow path 59 is opened, the internal space of the cap 51 is suctioned through the waste liquid flow path 59. Accordingly, the cleaning liquid remaining in the internal space of the cap 51 is discharged as the waste liquid from the discharge port 51d of the cap 51 to the waste liquid tank 58 through the waste liquid flow path 59.

Subsequently, the controller 70 executes a wiping operation, as the first maintenance processing, after the third waste liquid suction operation (step S6). In the wiping operation, as illustrated in FIG. 11, the controller 70 disposes the wiper 62 at the contact position and moves the head 20 rightward or leftward by the carriage 31. Accordingly, since the nozzle surface 22 of the head 20 moves rightward or leftward in the state of being in contact with the wiper 62, the nozzle surface 22 is wiped by the wiper 62, and the ink and the cleaning liquid on the nozzle surface 22 are removed by the wiper 62. Accordingly, it is possible to suppress the ink remaining on the nozzle surface 22 and the non-ejection of the ink caused by the cleaning liquid.

After the wiping operation, the controller 70 covers the upper opening of the internal space of the cap 51 by the nozzle surface 22. Accordingly, since the nozzle surface 22 is covered by the cap 51, it is possible to suppress drying of the ink in the nozzles 21 opened in the nozzle surface 22 and the non-ejection of the ink caused by the drying.

### Second Maintenance Processing

The second maintenance processing is executed by the controller 70 along a flowchart illustrated in the example of FIG. 4B. In the flowchart of FIG. 4B, processing of steps S1 and S2 in the flowchart of FIG. 4A is not executed, and processing of step S7 is executed instead of the processing of step S3. Therefore, in the second maintenance processing, processing of steps S4 to S6 is executed following the processing of step S7.

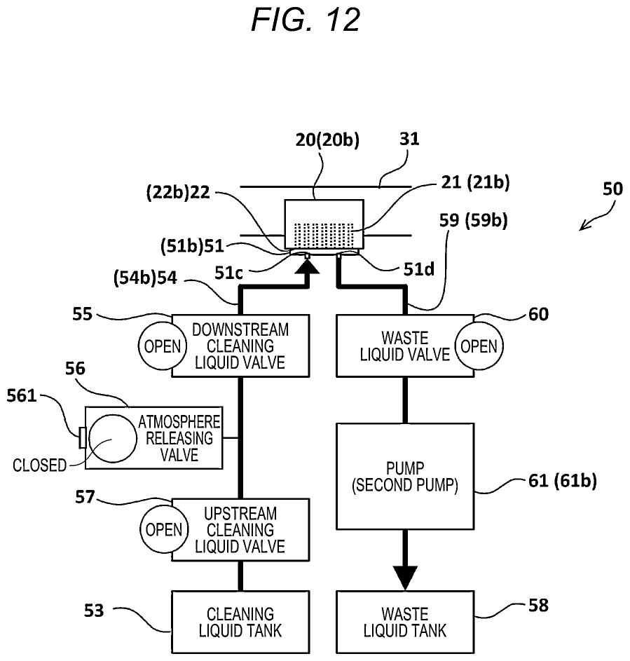

Specifically, in the second maintenance processing, the controller 70 executes second cleaning liquid introduction operation, instead of the first cleaning liquid introduction operation, without executing the ink suction operation and the first waste liquid suction operation (step S7). In the second cleaning liquid introduction operation, as illustrated in FIG. 12, the controller 70 disposes the cap 51 at the contact position and causes the cap 51 to come into contact with the nozzle surface 22, thereby covering the internal space of the cap 51 by the nozzle surface 22. In this state, the controller 70 closes the atmosphere releasing valve 56 and opens the downstream cleaning liquid valve 55 and the upstream cleaning liquid valve 57. Accordingly, the atmosphere releasing port 561 is closed, but the cleaning liquid flow path 54 between the supply port 51c of the cap 51 and the cleaning liquid tank 53 is opened. Accordingly, the cleaning liquid tank 53 and the internal space of the cap 51 communicate with each other.

In a case where the controller 70 drives the pump 61 in a state where the waste liquid valve 60 is opened and the waste liquid flow path 59 is opened, the internal space of the cap 51 is suctioned through the waste liquid flow path 59. Accordingly, the cleaning liquid is introduced into the internal space of the cap 51 from the cleaning liquid tank 53 through the cleaning liquid flow path 54, and the nozzle surface 22 exposed to the internal space of the cap 51 is cleaned by the cleaning liquid introduced into the internal space. Accordingly, the thickened ink in the nozzles 21 on the nozzle surface 22 is removed by the cleaning liquid, and thus it is possible to suppress the non-ejection of the nozzles 21.

The controller 70 drives the pump 61 such that the suction force of the pump 61 in the second cleaning liquid introduction operation is larger than that in the first cleaning liquid introduction operation. Since the inside of the cap 51 is suctioned by the pump 61, a pressure in the internal space of the cap 51 in the second cleaning liquid introduction operation becomes lower than a pressure in the internal space of the cap 51 in the first cleaning liquid introduction operation.

For example, the pressure in the internal space of the cap 51 is lower than a predetermined pressure that causes the meniscus break in the nozzles 21. Therefore, in a case where the meniscus break occurs due to the second cleaning liquid introduction operation, the cleaning liquid is introduced into the internal space of the cap 51. Due to the meniscus break, the thickened ink is ejected from the nozzles 21, and the thickened ink is removed from the nozzles 21 by the cleaning liquid. Accordingly, the non-ejection of the head 20 can be suppressed.

Subsequently, the controller 70 executes the second waste liquid suction operation, as second maintenance processing, after the second cleaning liquid introduction operation (step S4). The second waste liquid suction operation in the second maintenance processing is similar to that in the first maintenance processing. Therefore, by the second waste liquid suction operation, the ink and the cleaning liquid in the cap 51 are discharged as the waste liquid from the discharge port 51d of the cap 51 to the waste liquid tank 58 through the waste liquid flow path 59.

As described above, in the second maintenance processing, the second cleaning liquid introduction operation of step S7 and the second waste liquid suction operation of step S4 are executed. In the second cleaning liquid introduction operation, the controller 70 continuously drives the pump 61. For example, as illustrated in FIG. 8B, the controller 70 continuously drives the pump 61, during a second driving period c, once in the second cleaning liquid introduction operation.

The second driving period c, which is a total driving period of the pump 61 in the second cleaning liquid introduction operation, is longer than one first driving period in an intermittent operation of the pump 61 in the first cleaning liquid introduction operation illustrated in FIG. 8A. Further, the second driving period c is shorter than a total driving period of the pump 61 in the first cleaning liquid introduction operation, that is, a total sum (for example, 3a) of all the first driving periods a. Accordingly, the suction force of the pump 61 in the second cleaning liquid introduction operation is lower than the suction force of the pump 61 in the first cleaning liquid introduction operation. Therefore, the pressure in the internal space of the cap 51 caused by the suction of the pump 61 in the second cleaning liquid introduction operation is higher than the pressure in the internal space of the cap 51 caused by the suction of the pump 61 in the first cleaning liquid introduction operation. Thus, the amount of the cleaning liquid introduced into the internal space of the cap 51 is likely to be smaller in the second cleaning liquid introduction operation than in the first cleaning liquid introduction operation.

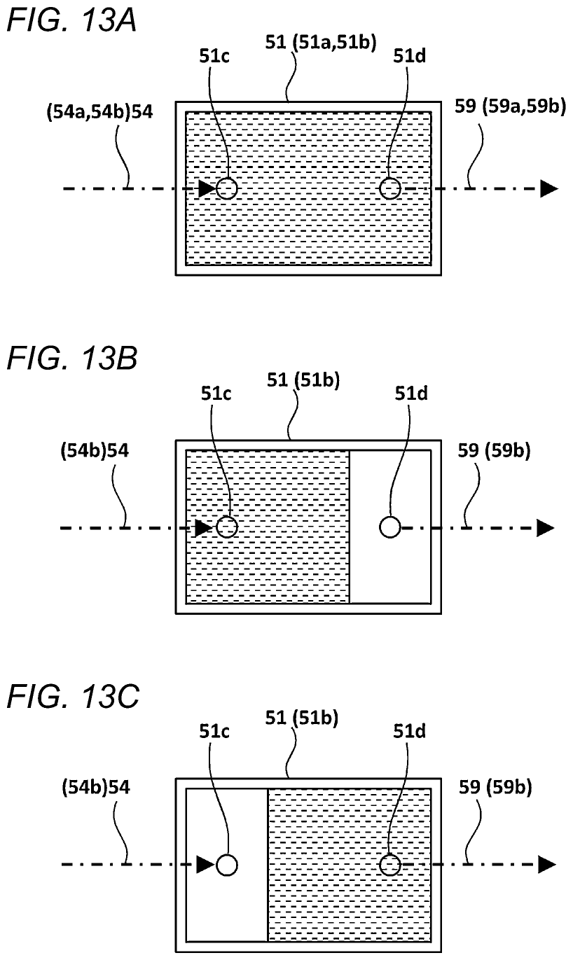

For example, as illustrated in FIG. 13A, the entire internal space of the cap 51 is more easily filled with the cleaning liquid in the first cleaning liquid introduction operation than in the second cleaning liquid introduction operation. On the other hand, in the second cleaning liquid introduction operation, as illustrated in FIG. 13B, a part (for example, ⅔ of the whole) of the internal space of the cap 51 is filled with the cleaning liquid, and the other part is easily filled with air. Since the cleaning liquid flows from the supply port 51c into the internal space of the cap 51 whose upper opening is covered by the nozzle surface 22, a portion in the cap 51 closer to the supply port 51c than to the discharge port 51d is filled. In the portion close to the supply port 51c, both the nozzle surface 22 and a bottom surface of the cap 51 facing the nozzle surface 22 are more easily wet than a portion far from the supply port 51c by the cleaning liquid. Thus, portions of the nozzle surface 22 and the cap 51 closer to the supply port 51c than to the discharge port 51d are cleaned with the cleaning liquid.

In the second waste liquid suction operation after the second cleaning liquid operation, while the upper opening of the internal space of the cap 51 is covered by the nozzle surface 22, the internal space of the cap 51 is suctioned by the pump 61 through the discharge port 51d, and the air flows into the internal space of the cap 51 through the supply port 51c. Accordingly, as illustrated in FIG. 13C, it is considered that the cleaning liquid moves from the supply port 51c toward the discharge port 51d in a state where both the nozzle surface 22 and the bottom surface of the cap 51 are wet in the internal space of the cap 51. Accordingly, portions of the nozzle surface 22 and the cap 51 closer to the discharge port 51d than to the supply port 51c are cleaned by the cleaning liquid.

As described above, in the second cleaning liquid introduction operation, the amount of the cleaning liquid to be introduced is small, and thus the amount of the waste liquid containing the cleaning liquid can be reduced. Further, in the second cleaning liquid introduction operation and the second waste liquid suction operation, the cleaning liquid moves in the internal space of the cap 51, so that the entire nozzle surface 22 exposed to the internal space of the cap 51 is cleaned by the cleaning liquid, and the non-ejection of the nozzle 21 opened in the nozzle surface 22 can be suppressed.

Subsequently, the controller 70 executes the third waste liquid suction operation and the wiping operation in this order, as the second maintenance processing, after the second waste liquid suction operation (steps S5 and S6). The third waste liquid suction operation and the wiping operation in the second maintenance processing are similar to those in the first maintenance processing. Therefore, by the third waste liquid suction operation, the ink and the cleaning liquid in the cap 51 are discharged as the waste liquid from the discharge port 51d of the cap 51 to the waste liquid tank 58 through the waste liquid flow path 59. By the wiping operation, the ink and the cleaning liquid on the nozzle surface 22 are removed by the wiper 62.

The controller 70 may execute the third waste liquid suction operation and the wiping operation simultaneously, in the second maintenance processing. As described above, execution time of the second maintenance processing can be shortened by executing the third waste liquid suction operation and the wiping operation in parallel, as compared with the execution of the third waste liquid suction operation and the wiping operation continuously.

### Flow of Maintenance of Printing Device

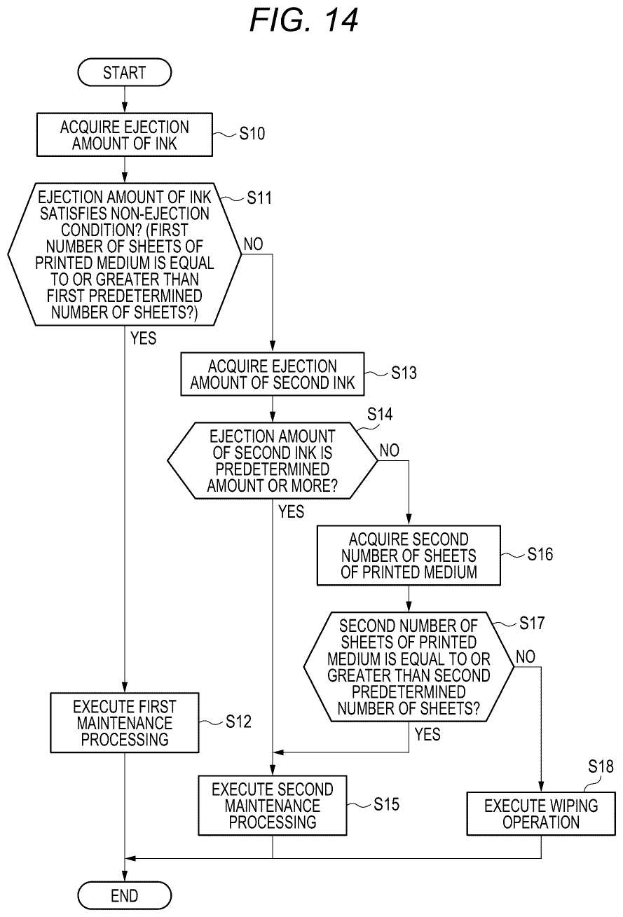

The maintenance of the printing device 10 is executed by the controller 70 according to a flowchart illustrated in the example of FIG. 14. The maintenance may be executed every time a predetermined condition is satisfied, for example, every printing processing or every predetermined period.

First, the controller 70 acquires, from the storage unit 71, an ejection amount of the ink (step S10). As the ejection amount of the ink, for example, a first number x, which is the number of printed mediums A printed with the ink, may be used. In this case, the controller 70 accumulates the number of the printed mediums A for each execution of the printing processing from a reset, and stores the accumulated number as the first number x in the storage unit 71. The first number x is used as a counter for the first maintenance processing and is reset by the execution of the first maintenance processing.

Subsequently, the controller 70 executes determination processing of determining whether the ejection amount of ink satisfies a non-ejection condition (step S11). The non-ejection condition is, for example, that the first number x of the printed mediums A is a first predetermined number, for example, 24 or more. In this case, in the determination processing, the controller 70 determines whether the first number x of the printed mediums A acquired in step S10 is equal to or greater than the first predetermined number. Here, in a case where the first number x of the printed mediums A is equal to or greater than the first predetermined number, the controller 70 determines that the ejection amount of the ink satisfies the non-ejection condition (step S11: YES). On the other hand, in a case where the first number x of the printed mediums A is less than the first predetermined number, the controller 70 determines that the ejection amount of ink does not satisfy the non-ejection condition (step S11: NO).

Subsequently, in a case where it is determined that the ejection amount of ink satisfies the non-ejection condition in the determination processing of step S11 (step S11: YES), the controller 70 executes the first maintenance processing of the first nozzle 21a and the second nozzle 21b (step S12). In the first maintenance processing, the controller 70 executes each operation of steps S1 to S6 illustrated in FIG. 4A for each of the first nozzle 21a and the second nozzle 21b.

Then, the first maintenance processing is executed on each of the first nozzle 21a and the second nozzle 21b. Therefore, after the execution of the first maintenance processing, the controller 70 resets the first number x, which is a counter for the first maintenance processing, and the second number y, which is a counter for the second maintenance processing to be described later, to 0.

On the other hand, in the determination processing of step S11, in a case where it is determined in the determination processing that the ejection amount of the ink does not satisfy the non-ejection condition (step S11: NO), the controller 70 acquires the ejection amount of the second ink from the storage unit 71 (step S13). The ejection amount of the second ink is the amount of the second ink ejected from the second nozzles 21b in the previous printing processing executed immediately before the execution of the maintenance processing. Therefore, the controller 70 acquires the printing data of the previous printing processing stored in the storage unit 71, and acquires the dot size and the number of dots of the second ink in the printing processing based on the printing data. Then, the controller 70 acquires, as the ejection amount of the second ink, a product of the ejection amount of the second ink corresponding to the dot size and the number of times of ejection of the second ink corresponding to the number of dots.

Subsequently, the controller 70 determines whether the ejection amount of the second ink is a predetermined amount, for example, 8 cc or more (step S14). Here, in a case where it is determined that the ejection amount of the second ink is equal to or greater than the predetermined amount (step S14: YES), the controller 70 executes the second maintenance processing of the second nozzle 21b (step S15). In the second maintenance processing, the controller 70 executes the operations of steps S7 and S4 to S6 illustrated in FIG. 4B with respect to the second nozzle 21b. Here, the second maintenance processing is not executed on the first nozzle 21a.

In the second cleaning liquid introduction operation of step S7, the controller 70 suctions the inside of the second cap 51b to introduce the cleaning liquid into the second cap 51b, in a state where the second cap 51b is in contact with the second nozzle surface 22b and the second cleaning liquid flow path 54b is opened. Accordingly, even in a case where the second nozzle 21b is likely to not eject due to the second ink that is likely to dry, since the second nozzle surface 22b on which the second nozzle 21b is opened is cleaned by the cleaning liquid, the non-ejection of the second nozzle 21b can be suppressed.

In the second maintenance processing, the ink suction operation for the first nozzles 21a and the second nozzles 21b and the second cleaning liquid introduction operation for the first nozzles 21a are not executed. Accordingly, the ink is not ejected from the first nozzles 21a or the second nozzles 21b by the ink suction operation, and the cleaning liquid is not introduced into the first cap 51a by the second cleaning liquid introduction operation. Thus, the amount of the waste liquid containing the ink and the cleaning liquid can be reduced.

As described above, in a case where the second maintenance processing is executed, the controller 70 resets, to 0, the second number y, which is the counter for the second maintenance processing, without resetting the first number x, which is the counter for the first maintenance processing, to 0. The second number y is the number of the printed mediums A printed with the ink. The second number y of the printed mediums A is reset by the execution of the second maintenance processing, the number of the printed mediums A printed by the printing processing is accumulated every time the subsequent printing processing is executed, and the accumulated number is stored in the storage unit 71 by the controller 70 as the second number y.

On the other hand, in the determination processing of step S14, in a case where it is determined that the ejection amount of the second ink is less than the predetermined amount (step S14: NO), the controller 70 acquires the second number y of the printed mediums A from the storage unit 71 (step S16). Then, the controller 70 determines whether the second number y of the printed mediums A is a second predetermined number, for example, six or more (step S17). Here, when the second number y of the printed mediums A is equal to or greater than the second predetermined number (step S17: YES), the controller 70 executes the second maintenance processing of the second nozzles 21b (step S15). Accordingly, it is possible to suppress the non-ejection of the second nozzle 21b while reducing the amount of the waste liquid including the ink and the cleaning liquid.

After the execution of the second maintenance processing, the controller 70 resets, to 0, the second number y, which is the counter for the maintenance processing of the second nozzle 21b, without resetting the first number x, which is the counter for the maintenance processing of the first nozzle 21a, to 0.

On the other hand, in the determination processing of step S17, in a case where the second number y of the printed mediums A is less than the second predetermined number (step S17: NO), the controller 70 executes the wiping operation on the first nozzle surface 22a and the second nozzle 21b (step S18). By removing the ink and the cleaning liquid on the first nozzle surface 22a and the second nozzles 21b by the wiper 62 through the wiping operation, it is possible to suppress the non-ejection of the ink caused by the ink and the cleaning liquid remaining on the first nozzle surface 22a and the second nozzles 21b.

After executing the wiping operation, the controller 70 does not reset the first number x or the second number y which are counters for the maintenance processing. In a case where the first maintenance processing of step S12, the second maintenance processing of step S15, and the wiping operation are executed, the controller 70 ends the maintenance, and covers the first nozzle surface 22a with the first cap 51a and covers the second nozzle 21b with the second cap 51b.

As illustrated in the maintenance of the printing device 10 described above, the controller 70 selectively executes the first maintenance processing and the second maintenance processing, as the maintenance processing of the nozzles 21, depending on whether the ejection amount of the ink satisfies the non-ejection condition. Here, in a case where the ejection amount of the ink satisfies the non-ejection condition in which both the first nozzles 21a and the second nozzles 21b are likely to be non-ejection, the first maintenance processing is executed on both the first nozzles 21a and the second nozzles 21b. On the other hand, in a case where the ejection amount of the ink does not satisfy the non-ejection condition, the second maintenance processing is not executed on the first nozzles 21a, and the second maintenance processing is executed on the second nozzles 21b that are more likely to be non-ejection than the first nozzle 21a.

Accordingly, since the number of times of execution of the maintenance processing is larger in the second nozzles 21b than in the first nozzles 21a, it is possible to suppress the non-ejection of the second nozzles 21b even in a case where the second nozzles 21b are more likely to be non-ejection due to the second ink that is more likely to dry than the first ink. On the other hand, with respect to the first nozzles 21a that eject the first ink that is harder to dry than the second ink, the number of times of execution of the maintenance processing is suppressed to be smaller than that of the second nozzles 21b, and the amount of the waste liquid can be reduced.

The first predetermined number for determining the execution of the first maintenance processing in step S11 is larger than the second predetermined number for determining the execution of the second maintenance processing in step S14. Therefore, the number of times of execution of the maintenance processing for the first nozzles 21a is reduced, and the amount of the waste liquid can be reduced.

### Other Modifications

In step S10 of FIG. 14, the controller 70 acquires, for example, the number of the printed mediums A printed with ink as an ejection amount of the ink, but the ejection amount of the ink is not limited thereto. For example, the controller 70 may acquire the amount of ink used for printing on the printed mediums A in previous printing processing as the ejection amount of the ink.

In this case, the controller 70 acquires the printing data of previous printing processing stored in the storage unit 71 after the execution of the previous printing processing, and acquires a dot size and the number of dots of the ink including first ink and second ink in the previous printing processing based on the printing data. Then, the controller 70 acquires a product of the ejection amount of ink corresponding to the dot size and the number of times of ejection corresponding to the number of dots as the amount of ink used for printing on the printed mediums A in the previous printing processing.

In the determination processing of step S11, the controller 70 determines whether the amount of ink used for printing on the printed mediums A in the previous printing processing is equal to or greater than a predetermined amount. In a case where the amount of ink in the previous printing processing is equal to or greater than a predetermined amount, the controller 70 determines that the ejection amount of the ink satisfies a non-ejection condition. On the other hand, in a case where the amount of ink in the previous printing processing is less than the predetermined amount, the controller 70 determines that the ejection amount of ink does not satisfy the non-ejection condition. In addition to the previous printing processing, an accumulated amount that is an amount of ink used for printing from a reset to the previous printing processing may be acquired as the ejection amount of ink and used in the determination processing of step S11.

In the determination processing of step S11, the controller 70 uses the ejection amount of the ink as an ink ejection condition, but the ink ejection condition is not limited to the ejection amount of the ink. For example, the controller 70 may use a temperature of the printing device 10, as the ink ejection condition. In this case, in a case where a temperature measured by a thermometer provided in the printing device 10 is equal to or higher than a predetermined temperature, the ink in the nozzles 21 is easily dried, and thus the controller 70 may determine that the ink ejection condition satisfies the non-ejection condition. On the other hand, in a case where the measured temperature is lower than the predetermined temperature, the controller 70 may determine that the ink ejection condition does not satisfy the non-ejection condition.

Further, in the determination processing of step S11, for example, the controller 70 may use humidity in the printing device 10, as the ink ejection condition. In this case, in a case where the humidity measured by a hygrometer provided in the printing device 10 is less than predetermined humidity, the ink in the nozzles 21 is likely to dry, and thus the controller 70 may determine that the ink ejection condition satisfies the non-ejection condition. On the other hand, in a case where the measured humidity is equal to or higher than the predetermined humidity, the controller 70 may determine that the ink ejection condition does not satisfy the non-ejection condition.

Further, in the determination processing of step S11, for example, the controller 70 may use elapsed time from the previous ink ejection as the ink ejection condition. In this case, when the ink is ejected from the nozzles 21 by the ink suction operation of the printing processing or the first maintenance processing, the controller 70 measures the elapsed time from the ejection. In a case where the elapsed time is equal to or longer than the predetermined time, since the ink in the nozzle 21 is likely to dry, the controller 70 may determine that the ink ejection condition satisfies the non-ejection condition. On the other hand, in a case where the elapsed time is less than the predetermined time, the controller 70 may determine that the ink ejection condition does not satisfy the non-ejection condition.

In step S10 of FIG. 14, the controller 70 acquires the ejection amount of the ink used in the printing processing that has already been executed before the execution of the processing of step S10, but the ejection amount of the ink is not limited thereto. For example, the controller 70 may acquire the ejection amount of the ink used in the printing processing to be executed.

For example, in a case where the ejection amount of the ink is the amount of ink used for printing on the printed mediums A in current printing processing to be executed, in a case where the current printing data is acquired, the controller 70 may acquire the amount of ink used in the current printing processing as the ejection amount of the ink based on the printing data. Accordingly, before execution of the current printing processing, the controller 70 may determine whether to execute the first maintenance processing in step S11, based on the amount of ink to be ejected in the printing processing. In addition to the current printing processing, an accumulated amount, which is an amount of ink used for printing from the reset to the current printing processing, may be acquired as the ejection amount of ink and used in the determination processing of step S11.

In a case where the ejection amount of ink is the number of the printed mediums A, the controller 70 may acquire, as the first number x, the number obtained by adding the number of the printed mediums A to be printed in the current printing processing to be executed to the cumulative number of the printed mediums A printed in the printing processing already executed before the execution of the processing of step S10. Accordingly, before execution of the current printing processing, the controller 70 may determine whether to execute the first maintenance processing in step S11 based on the first number x obtained by adding the number of the printed mediums A to be printed in the current printing processing.

Further, in step S13 of FIG. 14, the controller 70 acquires the ejection amount of the second ink used in the previous printing processing that has already been executed before the execution of the processing of step S13, but the ejection amount of the second ink is not limited thereto. For example, the controller 70 may acquire the ejection amount of the second ink to be used in the current printing processing to be executed based on the printing data. In this case, in a case where the current printing data is acquired, the controller 70 may acquire the ejection amount of the second ink in the current printing processing based on the printing data. Accordingly, before the current printing processing is executed, the controller 70 may determine whether to execute the second maintenance processing in step S14 based on the amount of the second ink to be ejected in the printing processing.

Further, in step S16 of FIG. 14, the controller 70 acquires the second number y which is the cumulative number of the printed mediums A printed in the printing processing already executed before the execution of the processing of step S16. but the second number y is not limited thereto. For example, the controller 70 may acquire, as the second number y, the number obtained by adding the number of the printed mediums A to be printed in the current printing processing to be executed to the cumulative number of the printed mediums A printed in the printing processing already executed before the execution of the processing of step S16. Accordingly, before the execution of the current printing processing, the controller 70 may determine whether to execute the second maintenance processing in step S17, based on the second number y obtained by adding the number of the printed mediums A to be printed in the printing processing.

The flowchart of FIG. 14 includes step S14 and step S17. In this case, in a case where the ejection amount of the second ink is equal to or greater than the predetermined amount (step S14: YES), and in a case where the second number y of the printed mediums A is equal to or greater than the second predetermined number (step S17: YES), the controller 70 executes the second maintenance processing. In contrast, the flowchart of FIG. 14 may include any one of step S14 and step S17. In this case, in a case where the ejection amount of the second ink is equal to or greater than the predetermined amount (step S14: YES), or in a case where the second number y of the printed mediums A is equal to or greater than the second predetermined number (step S17: YES), the controller 70 executes the second maintenance processing.

Further, in a case where the second number y of the printed mediums A is less than the second predetermined number (step S17: NO), the controller 70 executes the wiping operation in step S18, but the operation is not limited thereto. For example, the controller 70 may execute a flushing operation in addition to the wiping operation. The controller 70 may end the maintenance without executing the operation such as the wiping operation in step S18.

The controller 70 acquires the ejection amount of the ink in step S10 of FIG. 14, the ejection amount of the second ink in step S13, and the second number y of the printed mediums A in step S16 from the storage unit 71, but the method of acquiring the data is not limited thereto. For example, the controller 70 may acquire the data from the interface 72, the input device 73, or the like.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing device comprising:
an inkjet head including a nozzle surface on which a nozzle configured to eject ink is opened;
a cap configured to be in contact with the nozzle surface;
a cleaning liquid tank configured to be connected to the cap through a cleaning liquid flow path, the cleaning liquid tank being configured to store a cleaning liquid;
a waste liquid tank configured to be connected to the cap through a waste liquid flow path, the waste liquid tank being configured to store a waste liquid including at least one of the ink or the cleaning liquid supplied to the cap; and
a controller,
wherein the controller is configured to selectively perform:
first maintenance processing of the nozzle using the cleaning liquid; and
second maintenance processing of the nozzle using the cleaning liquid, the second maintenance processing having a smaller amount of the waste liquid than the first maintenance processing.

2. The printing device according to claim 1, further comprising:
a pump configured to be provided in the waste liquid flow path, the pump being configured to suction an inside of the cap,
wherein the controller is configured to perform, as the first maintenance processing:
an ink suction operation of suctioning the inside of the cap in a state where the cap is in contact with the nozzle surface and the cleaning liquid flow path is closed; and
after the ink suction operation, a first cleaning liquid introduction operation of suctioning the inside of the cap in a state where the cap is in contact with the nozzle surface and the cleaning liquid flow path is opened, to introduce the cleaning liquid into the cap, and
the controller is configured to perform, as the second maintenance processing:
without executing the ink suction operation, a second cleaning liquid introduction operation of suctioning the inside of the cap in the state where the cap is in contact with the nozzle surface and the cleaning liquid flow path is opened, to introducing the cleaning liquid into the cap.

3. The printing device according to claim 1, further comprising:
a pump configured to be provided in the waste liquid flow path, the pump configured to suction an inside of the cap,
wherein the controller is configured to perform, as the first maintenance processing:
a first cleaning liquid introduction operation of suctioning the inside of the cap in a state where the cap is in contact with the nozzle surface and the cleaning liquid flow path is opened, to introduce the cleaning liquid into the cap, and
the controller is configured to perform, as the second maintenance processing:
in a driving period of the pump shorter than a driving period of the first cleaning liquid introduction operation, a second cleaning liquid introduction operation of suctioning the inside of the cap in the state where the cap is in contact with the nozzle surface and the cleaning liquid flow path is opened, to introduce the cleaning liquid into the cap.

4. The printing device according to claim 2,
wherein the controller is configured to perform:
determination processing of determining whether an ink ejection condition satisfies a non-ejection condition;
in a case where the ink ejection condition satisfies the non-ejection condition in the determination processing, the first maintenance processing; and
in a case where the ink ejection condition does not satisfy the non-ejection condition in the determination processing, the second maintenance processing.

5. The printing device according to claim 4,
wherein, in a case where a number of printed mediums printed with the ink is equal to or greater than a predetermined number, or in a case where an amount of the ink used for printing the printed mediums is equal to or greater than a predetermined amount, the controller is configured to determine that the ink ejection condition satisfies the non-ejection condition in the determination processing.

6. The printing device according to claim 2,
wherein the controller is configured to suction the inside of the cap to cause a pressure inside the cap in the second cleaning liquid introduction operation to be lower than a pressure inside the cap in the first cleaning liquid introduction operation.

7. The printing device according to claim 1,
wherein the nozzle surface includes:
a first nozzle surface on which a first nozzle configured to eject first ink is opened; and
a second nozzle surface on which a second nozzle configured to eject second ink is opened, the second ink being easier to dry than the first ink,
the cap includes:
a first cap configured to be in contact with the first nozzle surface; and
a second cap configured to be in contact with the second nozzle surface,
the cleaning liquid flow path includes:
a first cleaning liquid flow path connected to the first cap; and
a second cleaning liquid flow path connected to the second cap,
the waste liquid flow path includes:
a first waste liquid flow path connected to the first cap; and
a second waste liquid flow path connected to the second cap,
the printing device further comprises:
a first pump configured to be provided in the first waste liquid flow path, the first pump being configured to suction an inside of the first cap; and
a second pump configured to be provided in the second waste liquid flow path, the second pump being configured to suction an inside of the second cap,
the controller is configured to perform, as the first maintenance processing:
an ink suction operation of suctioning the inside of the first cap in a state where the first cap is in contact with the first nozzle surface and the first cleaning liquid flow path is closed, and suctioning the inside of the second cap in a state where the second cap is in contact with the second nozzle surface and the second cleaning liquid flow path is closed; and
after the ink suction operation, a first cleaning liquid introduction operation of suctioning the inside of the first cap in a state where the first cap is in contact with the first nozzle surface and the first cleaning liquid flow path is opened to introduce the cleaning liquid into the first cap, and suctioning the inside of the second cap in a state where the second cap is in contact with the second nozzle surface and the second cleaning liquid flow path is opened to introduce the cleaning liquid into the second cap, and
the controller is configured to perform, as the second maintenance processing:
without performing the ink suction operation and introducing the cleaning liquid into the first cap, a second cleaning liquid introduction operation of suctioning the inside of the second cap in the state where the second cap is in contact with the second nozzle surface and the second cleaning liquid flow path is opened to introduce the cleaning liquid into the second cap.

8. A control method of a printing device, the printing device including:
an inkjet head including a nozzle surface on which a nozzle configured to eject ink is opened;
a cap configured to be in contact with the nozzle surface;
a cleaning liquid tank configured to be connected to the cap through a cleaning liquid flow path, the cleaning liquid tank being configured to store a cleaning liquid; and
a waste liquid tank configured to be connected to the cap through a waste liquid flow path, the waste liquid tank being configured to store a waste liquid including at least one of the ink or the cleaning liquid supplied to the cap,
the control method comprising selectively performing:
first maintenance processing of the nozzle using the cleaning liquid; and
second maintenance processing of the nozzle using the cleaning liquid, the second maintenance processing having a smaller amount of the waste liquid than the first maintenance processing.

9. A non-transitory computer readable storage medium storing a computer program executed by a printing device, the printing device includes:
an inkjet head including a nozzle surface on which a nozzle configured to eject ink is opened;
a cap configured to be in contact with the nozzle surface;
a cleaning liquid tank configured to be connected to the cap through a cleaning liquid flow path, the cleaning liquid tank being configured to store a cleaning liquid; and
a waste liquid tank configured to be connected to the cap through a waste liquid flow path, the waste liquid tank being configured to store a waste liquid including at least one of the ink or the cleaning liquid supplied to the cap,
the computer program comprising an instruction that causes the printing device to selectively perform:
first maintenance processing of the nozzle using the cleaning liquid; and
second maintenance processing of the nozzle using the cleaning liquid, the second maintenance processing having a smaller amount of the waste liquid than the first maintenance processing.
